(19) United States
(12) Patent Application Publication
(10) Pub. No.: US 2025/0330892 A1
(43) Pub. Date: Oct. 23, 2025

(54) APPARATUS, SYSTEM, AND METHOD OF AN ULTRA HIGH RELIABILITY (UHR) PARAMETERS UPDATE

(71) Applicant: INTEL CORPORATION, Santa Clara, CA (US)

(72) Inventors: Laurent Cariou, Milizac (FR); Thomas Kenney, Portland, OR (US)

(73) Assignee: INTEL CORPORATION, Santa Clara, CA (US)

(21) Appl. No.: 19/257,965

(22) Filed: Jul. 2, 2025

Related U.S. Application Data
(60) Provisional application No. 63/669,365, filed on Jul. 10, 2024.

(51) Int. Cl. H04W 40/24; H04W 12/0471; H04W 12/108

(52) U.S. Cl. CPC H04W 40/244; H04W 12/0471; H04W 12/108

(57) ABSTRACT

For example, an Ultra High Reliability (UHR) Access Point (AP) may be configured to configure a UHR parameters update element. For example, the UHR parameters update element may include an updated setting of one or more UHR parameters to be updated by the UHR AP in a critical update event. For example, the UHR AP may be configured to transmit a plurality of protected beacon frames during a critical update period before a time at which the one or more UHR parameters are to be updated. For example, a protected beacon frame of the plurality of protected beacon frames may include the UHR parameters update element.

### CROSS REFERENCE

This application claims the benefit of and priority from U.S. Provisional Patent Application No. 63/669,365 entitled “Retrieving Critical Updates in a Protected Manner”, filed Jul. 10, 2024, the entire disclosure of which is incorporated herein by reference.

### BACKGROUND

Devices in a wireless communication system may be configured to communicate various types of frames, which may include, for example, beacon frames, data frames, control frames, or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic flow-chart illustration of a method of an Ultra High Reliability (UHR) parameters update, in accordance with some demonstrative aspects.

FIG. 5 is a schematic flow-chart illustration of a method of a UHR parameters update, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020); IEEE 802.11be (IEEE P802.11be/D7.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 2: Enhancements for extremely high throughput (EHT), August 2024); and/or IEEE 802.11bn (IEEE P802.11bn/D0.3 Draft Standard for Information technology Telecommunications and information exchange between systems Local and metropolitan area networks—Specific requirements; Part 11: Wireless LAN Medium Access Control (MAC) and Physical Layer (PHY) Specifications; Amendment 6: Enhancements for ultra-high reliability (UHR), May 2025)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stack, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a sub-7 GHz frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 40 GHz, for example, a frequency band above 45 GHz, e.g., a 60 GHz frequency band, a frequency band between 42.5 GHz and 71 GHZ, and/or any other mmWave frequency band.

Some demonstrative aspects may be used in conjunction with a wireless communication network communicating over the sub-10 GHz frequency band and/or the mm Wave frequency band, e.g., as described below. However, other aspects may be implemented utilizing any other suitable wireless communication frequency bands, for example, a 5G frequency band, a frequency band below 20 GHz, a Sub 1 GHz (SIG) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mm Wave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mm Wave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

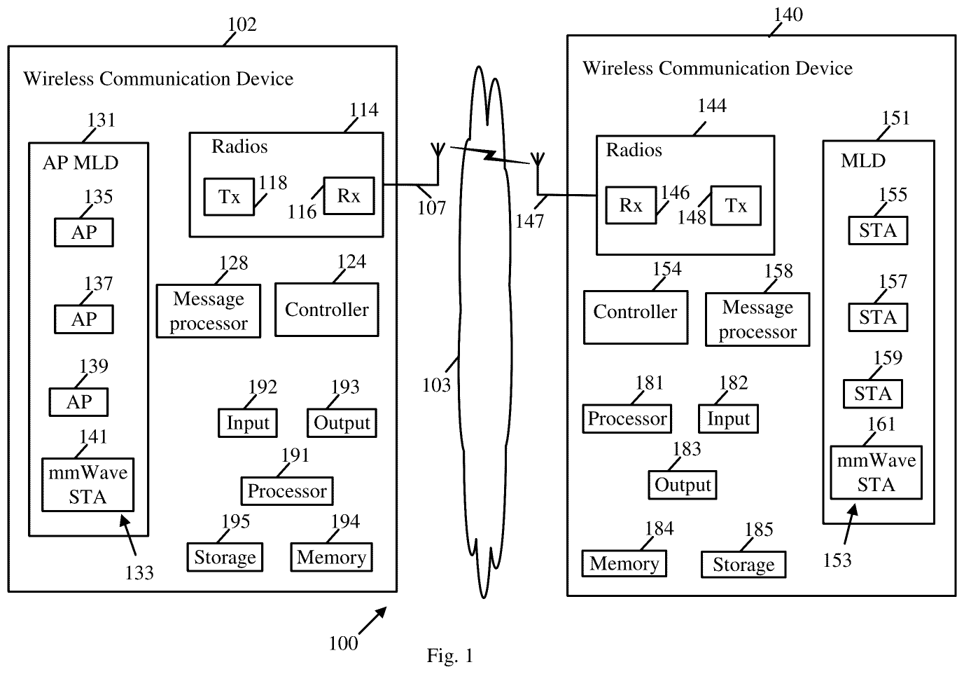

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, one or more channels in a sub-7 GHz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in an mmWave wireless communication frequency band, for example, one or more channels in a frequency band above 40 GHz, for example, one or more channels in a frequency band above 45 GHz, e.g., one or more channels in a 60 GHz frequency band, one or more channels in a frequency band between 42.5 GHz and 71 GHz, and/or one or more channels in any other mmWave frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 GHz band, for example, a sub-7 GHz band, for example, a 2.4 GHz band, a 5 GHz band, a 6 GHz band, and/or any other sub-10 GHz and/or sub-7 GHz band; and/or an mmWave band, e.g., a 45 GHz band, a 60 GHz band, a band between 42.5 GHz and 71 GHz, and/or any other mmWave band; and/or any other band, e.g., a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102 and/or device 140 may be configured to perform one or more operations, and/or functionalities of a Wi-Fi 8 STA.

In other aspects, for example, devices 102 and/or 140 may be configured to perform one or more operations, and/or functionalities of an Ultra High Reliability (UHR) STA.

In other aspects, for example, devices 102 and/or 140 may be configured to perform one or more operations, and/or functionalities of an Integrated mmWave (IMMW) STA.

In other aspects, for example, devices 102 and/or 140 may be configured to perform one or more operations, and/or functionalities of any other additional or alternative type of STA.

In other aspects, devices 102, and/or 140 may include, operate as, perform the role of, and/or perform one or more functionalities of, any other wireless device and/or station, e.g., a WLAN STA, a Wi-Fi STA, and the like.

In some demonstrative aspects, device 102 and/or device 140 may be configured to operate as, perform the role of, and/or perform one or more functionalities of, an access point (AP), e.g., an EHT AP STA, a UHR AP STA, and/or an IMMW AP STA.

In some demonstrative aspects, device 102 and/or device 140 may be configured to operate as, perform the role of, and/or perform one or more functionalities of, a non-AP STA, e.g., an EHT non-AP STA, a UHR non-AP STA, and/or an IMMW non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, a UHR network, an IMMW network, and/or any other network.

In some demonstrative aspects, device 102 and/or device 140 may be configured to operate in accordance with one or more Specifications, for example, including one or more IEEE 802.11 Specifications, e.g., an IEEE 802.11-2020 Specification, an IEEE 802.11be Specification, an IEEE 802.11bn Specification, and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, an mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 40 GHz, for example, a frequency band above 45 GHz, e.g., a 60 GHz frequency band, a frequency band between 42.5 GHz and 71 GHz, and/or any other mmWave frequency band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, for example, the one or more radios 144 may include, for example, a radio for communication by mmWave STA 161 over a fourth wireless communication frequency channel and/or frequency band, e.g., an mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

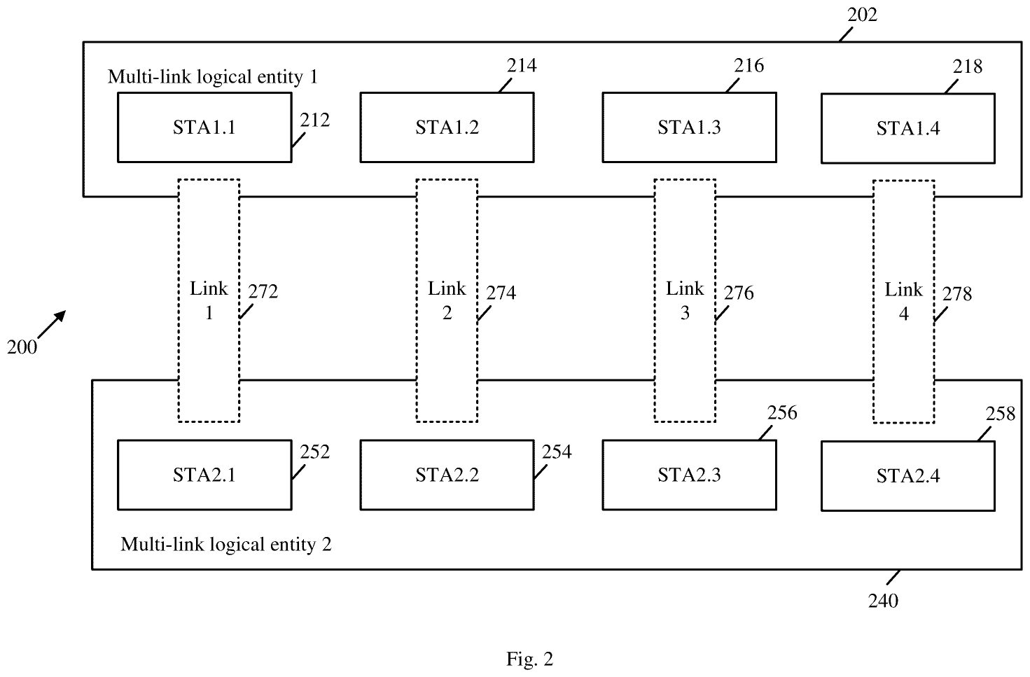

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

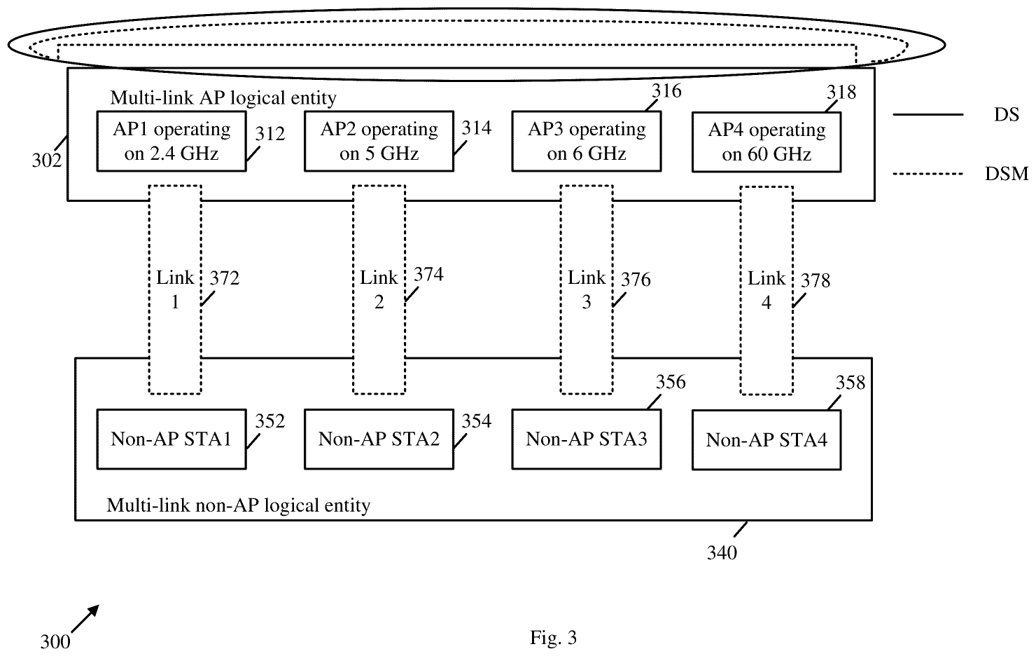

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, AP STA 316 may be configured to communicate over a 6 GHz frequency band, and/or mmWave STA 318 may be configured to communicate over an mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to perform one or more operations and/or functionalities of a UHR parameters update mechanism, e.g., as describe below.

In some demonstrative aspects, the UHR parameters update mechanism may be configured to provide a technical solution to support a UHR AP in updating one or more UHR parameters, e.g., as described below.

In some demonstrative aspects, the UHR parameters update mechanism may be configured to utilize a critical update mechanism, for example, to provide a technical solution to support the UHR AP in efficiently updating one or more UHR parameters, e.g., as described below.

In some demonstrative aspects, the UHR parameters update mechanism may be configured to provide a technical solution to support the UHR AP in efficiently updating one or more UHR parameters, for example, by utilizing one or more beacon frames, which may be communicated, for example, in accordance with the critical update mechanism, e.g., as described below.

In some demonstrative aspects, the UHR parameters update mechanism may be configured to provide a technical solution to support efficient communication of beacon frames, which may be configured, for example, to have a reduced length, e.g., as described below.

For example, in some use cases, implementations, and/or scenarios, beacon frames may become too large, for example, especially in enterprise scenarios with multiple Basic Service Set Identifier (BSSID) sets, and/or in other scenarios and/or use cases.

In some demonstrative aspects, device 102 and/or device 140 may be configured to perform one or more operations and/or functionalities of a UHR parameters update mechanism, which may be configured to provide a technical solution to support a long-term solution for updating parameters by an AP, for example, a long-term solution, which may be compatible with legacy devices (STAs), which may be adapted to greenfield UHR deployments, and/or which may provide one or more additional or alternative technical advantages, e.g., as described below.

In some demonstrative aspects, the UHR parameters update mechanism may be configured to support updating one or more types of UHR parameters, e.g., as described below.

In some demonstrative aspects, the UHR parameters update mechanism may be configured to provide a technical solution to support communication of beacon frames, which may be configured to carry one or more types of information, e.g., as described below.

For example, one or more beacon frames may be configured to carry information, e.g., dynamic information and/or short-term information, which may be allowed to be updated, and/or may be expected to be updated, relatively frequently.

For example, the dynamic information and/or short-term information may include information related to dynamic operational elements, e.g., including dynamic information, which may be needed for basic operation of associated STAs.

In one example, the dynamic operational elements may include a Traffic Indication Map (TIM) element, and/or any other suitable dynamic and/or static information elements.

For example, one or more, e.g., some or all, dynamic operational elements may be required to be present in all beacon frames.

For example, one or more beacon frames may be configured to carry information, e.g., static information and/or long-term information, which may be allowed to be updated, and/or may be expected to be updated, relatively infrequency.

For example, the static information and/or long-term information may include information related to BSS parameters, e.g., capabilities information, BSS operational information, and/or any other additional or alternative information related to BSS parameters.

For example, the BSS parameters may include one or more long-term static parameters, which include long term information that may rarely change.

For example, one or more, e.g., some or all, of the long-term static parameters may be excluded from some beacon frames.

For example, one or more, e.g., some or all, of the long-term static parameters may be provided by the AP to associated STAs, for example, as part of a probing procedure and/or an association procedure. Accordingly, the AP may be allowed to exclude one or more, e.g., some or all, of the long-term static parameters, for example, while providing the AP and associated STAs to update these long-term static parameters, for example, according to a critical update procedure, e.g., as described below.

For example, a critical update procedure may be configured to provide a technical solution for the AP to update the associated STAs to be aware of changes in the long-term static parameters, and to obtain the updates on the long-term static parameters from the AP, e.g., in accordance with the IEEE 802.11be Standard. For example, a critical update may be configured to parsing of a beacon frame is needed or not, and/or whether all elements are included in the beacon frame (e.g., per link).

For example, unassociated STAs may sometimes only need some basic discovery information, e.g., a BSSID, a Service Set Identifier (SSID), security parameters, what generation is supported, and/or any other additional or alternative basic discovery information, which may be utilized to support discovery of the AP and/or association with the AP. For example, if needed, the unassociated STAs may retrieve additional information, e.g., complete information, from the AP, e.g., through probing.

For example, beacon frames may be configured to provide to unassociated STAs basic discovery information, e.g., while excluding other information, for example, to support a proper, e.g., good, balance with probing.

In some demonstrative aspects, device 102 and/or device 140 may be configured to perform one or more operations and/or functionalities of a UHR parameters update mechanism, which may be configured to provide a technical solution to support communication of beacon frames having a reduced size, e.g., as described below.

In some demonstrative aspects, the size of UHR beacon frames may be reduced by defining one or more types of parameters, which may, e.g., must, be included in the UHR beacon frames, and/or by defining one or more types of parameters, which may, e.g., must, be excluded from the UHR beacon frames, e.g., as described below.

In some demonstrative aspects, it may be defined that beacon frames of UHR APs may be allowed to carry only one or more first predefined types of parameters, e.g., as described below.

In some demonstrative aspects, it may be defined that beacon frames of UHR APs may be restricted to carry only one or more first predefined types of parameters, e.g., as described below.

In some demonstrative aspects, it may be defined that beacon frames of UHR APs may not be allowed to carry one or more second predefined types of parameters, e.g., as described below.

In some demonstrative aspects, it may be defined that one or more second predefined types of parameters are to be excluded from beacon frames of UHR APs, e.g., as described below.

In some demonstrative aspects, it may be defined that beacon frames of a UHR AP are to be restricted to carry, e.g., to carry only, one or more, e.g., some or all, dynamic information parameters; and/or to carry, e.g., to carry only, basic discovery information, e.g., as described below.

In some demonstrative aspects, it may be defined that beacon frames of a UHR AP are to be restricted to carry, e.g., to carry only, all operational elements belonging to a dynamic operational elements category, and only basic discovery information, e.g., within a BSS parameters category, e.g., as described below.

In some demonstrative aspects, the operational elements belonging to a dynamic operational elements category may include, for example, TIM elements, and/or any other additional or alternative operational elements belonging to the dynamic operational elements category, e.g., as may be defined in accordance with an IEEE 802.11 Specification and/or any other suitable specification and/or protocol.

In some demonstrative aspects, the basic discovery information may be defined to include, for example, one or more information elements, which may be configured to support discovery.

For example, the basic discovery information may be defined to include a BSSID, an SSID, information to indicate one or more supported rates, information configured to indicate generation support, information configured to indicate MLD support, security information, e.g., basic security info, or the like.

For example, the basic discovery information may be defined to include information, which may be required by a non-AP STA, e.g., an unassociated STA, for example, when performing full scan with the intent to present to a user a list of available networks around.

In some demonstrative aspects, it may be defined that one or more, e.g., some or all, UHR elements carrying BSS capabilities and/or operation parameters are not to be included in beacon frames transmitted by a UHR AP, for example, except for a field indicating that the beacon frames are transmitted by a UHR AP.

In one example, STAs may obtain one or more, e.g., some or all, of the UHR BSS parameters, e.g., which are excluded from the beacon frames, for example, during a pre-association procedure, for example, through probe response frames and/or (re) association response frames.

In another example, one or more other additional or alternative parameters may be defined for signaling needed for UHR features.

In some demonstrative aspects, it may be defined that a UHR AP is to provide an indication of an update, for example, when there is a change to one or more UHR parameters.

For example, it may be defined that the UHR AP may perform one or more operations of an update mechanism, for example, to communicate one or more frames including one or more predefined fields, which may be configured to provide an indication of the updates.

In one example, the update mechanism may be configured to utilize one or more operations and/or functionalities, which may be configured based on, and/or in compliance with a critical update procedure, e.g., in accordance with an IEEE 802.11 Specification and/or any other suitable specification and/or protocol.

For example, UHR non-AP STAs may be configured to retrieve the updates from the UHR AP, for example, based on the indication of the updates from the UHR AP.

In some demonstrative aspects, device 102 and/or device 140 may perform one or more operations and/or functionalities of a UHR parameters update mechanism configured to provide a technical solution to support UHR non-AP STAs in retrieving critical updates, e.g., from a UHR AP, for example, in a protected manner, e.g., as described below.

In some demonstrative aspects, the UHR parameters update mechanism may be configured to provide a technical solution to support UHR non-AP STAs in retrieving one or more, e.g., some or all, critical updates, for example, with respect to changes in one or more fields of an UHR operation element, e.g., as described below.

In some demonstrative aspects, the UHR parameters update mechanism may be configured to provide a technical solution to support UHR non-AP STAs in retrieving one or more, e.g., some or all, critical updates, for example, with respect to changes in one or more fields of a UHR capabilities element, e.g., as described below.

In some demonstrative aspects, the UHR parameters update mechanism may be configured to provide a technical solution to support communicating critical updates in beacon frames, for example, during a critical update period, e.g., as described below.

In some demonstrative aspects, the UHR parameters update mechanism may be configured to provide a technical solution to support communicating critical updates in an unsolicited probe response frame that, for example, is broadcasted and protected, e.g., as described below.

In some demonstrative aspects, the UHR parameters update mechanism may be configured to provide a technical solution to support communicating critical updates in a unicasted probe response frame, which may be sent to a STA, for example, following a probe request frame transmitted by the STA to retrieve the critical updates, e.g., as described below.

In some demonstrative aspects, the UHR parameters update mechanism may be configured to provide a technical solution to support communicating critical updates in a new protected frame that can be, for example, broadcasted or unicasted, and which contains, for example, only the critical updates, e.g., as described below.

In some demonstrative aspects, controller 124 may be configured to control, trigger, cause, and/or instruct a UHR AP implemented by device 102 to configure a UHR parameters update element, e.g., as described below.

In some demonstrative aspects, controller 124 may be configured to control, trigger, cause, and/or instruct a UHR AP implemented by device 102 to configure a UHR parameters update element to include an updated setting of one or more UHR parameters to be updated by the UHR AP in a critical update event, e.g., as described below.

In some demonstrative aspects, controller 124 may be configured to control, trigger, cause, and/or instruct the UHR AP implemented by device 102 to transmit a plurality of protected beacon frames during a critical update period, for example, before a time at which the one or more UHR parameters are to be updated, e.g., as described below.

In some demonstrative aspects, controller 124 may be configured to control, trigger, cause, and/or instruct the UHR AP implemented by device 102 to configure a protected beacon frame of the plurality of protected beacon frames to include the UHR parameters update element, e.g., as described below.

In some demonstrative aspects, the protected beacon frame may include a count value, for example, based on a count of previous UHR parameter updates prior to the critical update event, e.g., as described below.

In some demonstrative aspects, the protected beacon frame may include timing information, for example, based on the time at which the one or more UHR parameters are to be updated, e.g., as described below.

In other aspects, the protected beacon frame may include any other additional or alternative parameters and/or information.

In some demonstrative aspects, controller 124 may be configured to mandate the UHR AP implemented by device 102 to protect all beacon frames transmitted by the UHR AP, e.g., as described below.

For example, controller 124 may be configured to mandate the UHR AP implemented by device 102 to protect, e.g., to mandatorily protect, all beacon frames transmitted by the UHR AP, for example, including any beacon frames transmitted by the UHR AP during the critical update period, and any beacon frames transmitted by the UHR AP outside critical update periods.

In other aspects, controller 124 may be configured to mandate the UHR AP implemented by device 102 to protect, e.g., to mandatorily protect, critical-update beacon frames transmitted by the UHR AP during the critical update period, and to allow the UHR AP to exclude from protection non-critical-update beacon frames transmitted by the UHR AP outside critical update periods.

In some demonstrative aspects, controller 124 may be configured to mandate the UHR AP implemented by device 102 to protect all broadcast probe response frames transmitted by the UHR AP, e.g., as described below.

For example, controller 124 may be configured to mandate the UHR AP implemented by device 102 to protect, e.g., to mandatorily protect, all broadcast probe response frames transmitted by the UHR AP, for example, including any broadcast probe response frames transmitted by the UHR AP during the critical update period, and any broadcast probe response frames transmitted by the UHR AP outside critical update periods.

In other aspects, controller 124 may be configured to mandate the UHR AP implemented by device 102 to protect, e.g., to mandatorily protect, critical-update broadcast probe response frames transmitted by the UHR AP during the critical update period, and to allow the UHR AP to exclude from protection non-critical-update broadcast probe response frames transmitted by the UHR AP outside critical update periods.

In some demonstrative aspects, controller 124 may be configured to mandate the UHR AP implemented by device 102 to protect all beacon frames and broadcast probe response frames transmitted by the UHR AP, e.g., as described below.

For example, controller 124 may be configured to mandate the UHR AP implemented by device 102 to protect, e.g., to mandatorily protect, all beacon frames and broadcast probe response frames transmitted by the UHR AP, for example, including any beacon frames and broadcast probe response frames transmitted by the UHR AP during the critical update period, and any beacon frames and broadcast probe response frames transmitted by the UHR AP outside critical update periods.

In other aspects, controller 124 may be configured to mandate the UHR AP implemented by device 102 to protect, e.g., to mandatorily protect, critical-update beacon frames and broadcast probe response frames transmitted by the UHR AP during the critical update period, and to allow the UHR AP to exclude from protection non-critical-update beacon frames and broadcast probe response frames transmitted by the UHR AP outside critical update periods.

In some demonstrative aspects, controller 124 may be configured to control, trigger, cause, and/or instruct the UHR AP implemented by device 102 to encapsulate the protected beacon frame, for example, according to a Broadcast/multicast Integrity Protocol (BIP), e.g., as described below.

In some demonstrative aspects, controller 124 may be configured to control, trigger, cause, and/or instruct the UHR AP implemented by device 102 to protect the plurality of protected beacon frames, for example, according to a Beacon Integrity Group Temporal Key (BIGTK), which is provided by the UHR AP to one or more associated UHR non-AP STAs, e.g., as described below.

In other aspects, controller 124 may be configured to control, trigger, cause, and/or instruct the UHR AP implemented by device 102 to protect the plurality of protected beacon frames according to any other additional or alternative key and/or protection mechanism.

In some demonstrative aspects, controller 124 may be configured to control, trigger, cause, and/or instruct an other UHR AP implemented by device 102, which belongs to a same AP MLD as the UHR AP, e.g., AP MLD 131, to transmit an other plurality of protected beacon frames including the UHR parameters update element, for example, during the critical update period, e.g., as described below.

In some demonstrative aspects, controller 124 may be configured to control, trigger, cause, and/or instruct the UHR AP implemented by device 102 to broadcast one or more unsolicited protected probe response frames during the critical update period, e.g., as described below.

In some demonstrative aspects, controller 124 may be configured to control, trigger, cause, and/or instruct the UHR AP implemented by device 102 to configure a protected probe response frame of the plurality of unsolicited protected probe response frames to include the UHR parameters update element, e.g., as described below.

In one example, controller 124 may be configured to control, trigger, cause, and/or instruct the UHR AP implemented by device 102 to broadcast one or more unsolicited protected probe response frames including a UHR parameters update element, and one or more protected beacon frames including the UHR parameters update element during a critical update period.

In another example, controller 124 may be configured to control, trigger, cause, and/or instruct the UHR AP implemented by device 102 to broadcast one or more unsolicited protected probe response frames including a UHR parameters update element during a critical update period, for example, instead of one or more, e.g., some or all, of the protected beacon frames.

In another example, controller 124 may be configured to control, trigger, cause, and/or instruct the UHR AP implemented by device 102 to broadcast one or more beacon frames, which do not include a UHR parameters update element, during a critical update period.

In some demonstrative aspects, controller 124 may be configured to control, trigger, cause, and/or instruct the UHR AP implemented by device 102 to protect the unsolicited protected probe response frames, for example, according to a BIGTK, which is provided by the UHR AP to one or more associated UHR non-AP STAs, e.g., as described below.

In other aspects, controller 124 may be configured to control, trigger, cause, and/or instruct the UHR AP implemented by device 102 to protect the unsolicited protected probe response frames according to any other additional or alternative key and/or protection mechanism.

In some demonstrative aspects, controller 124 may be configured to control, trigger, cause, and/or instruct the UHR AP implemented by device 102 to exclude the one or more UHR parameters from non-critical update beacon frames, which are transmitted outside critical update periods, e.g., as described below.

In some demonstrative aspects, the one or more UHR parameters, which are included in the UHR parameters update element, may include one or more long-term static parameters, e.g., as described below.

In some demonstrative aspects, the one or more UHR parameters, which are included in the UHR parameters update element, may include one or more UHR capability parameters corresponding to one or more UHR capabilities of the UHR AP, e.g., as described below.

In some demonstrative aspects, the one or more UHR parameters, which are included in the UHR parameters update element, may include one or more BSS parameters of a BSS of the UHR AP, e.g., as described below.

In some demonstrative aspects, the one or more UHR parameters, which are included in the UHR parameters update element, may include one or more Non-Primary Channel Access (NPCA) parameters, e.g., as described below.

In some demonstrative aspects, the one or more UHR parameters, which are included in the UHR parameters update element, may include one or more Dynamic power save (DPS) parameters, e.g., as described below.

In some demonstrative aspects, the one or more UHR parameters, which are included in the UHR parameters update element, may include one or more Enhanced Distributed Channel Access (EDCA) parameters, e.g., as described below.

In some demonstrative aspects, the one or more UHR parameters, which are included in the UHR parameters update element, may include one or more Dynamic Subband Operation (DSO) parameters, e.g., as described below.

In some demonstrative aspects, the one or more UHR parameters, which are included in the UHR parameters update element, may include one or more Dynamic Unavailability Operation (DUO) parameters, e.g., as described below.

In some demonstrative aspects, the one or more UHR parameters, which are included in the UHR parameters update element, may include one or more Dynamic Bandwidth Expansion (DBE) parameters, e.g., as described below.

In some demonstrative aspects, the one or more UHR parameters, which are included in the UHR parameters update element, may include one or more AP Power-Save (PS) parameters, e.g., as described below.

In other aspects, the UHR parameters update element may be configured to include any other additional or alternative UHR parameters.

In some demonstrative aspects, controller 124 may be configured to control, trigger, cause, and/or instruct the UHR AP implemented by device 102 to transmit a unicast probe response frame to a UHR non-AP STA, for example, based on a probe request frame received from the UHR non-AP STA, e.g., as described below.

In some demonstrative aspects, controller 124 may be configured to control, trigger, cause, and/or instruct the UHR AP implemented by device 102 to configure the unicast probe response frame to include the UHR parameters update element, e.g., as described below.

In some demonstrative aspects, controller 124 may be configured to control, trigger, cause, and/or instruct the UHR AP implemented by device 102 to transmit one or more UHR-update frames during the critical update period, e.g., as described below.

In some demonstrative aspects, controller 124 may be configured to control, trigger, cause, and/or instruct the UHR AP implemented by device 102 to configure a UHR-update frame of the one or more UHR-update frames to include the UHR parameters update element, e.g., as described below.

In some demonstrative aspects, controller 124 may be configured to control, trigger, cause, and/or instruct the UHR AP implemented by device 102 to configure the UHR-update frame to include an update-dedicated frame dedicated to carry the UHR parameters update element, e.g., as described below.

In other aspects, the UHR-update frame may include any other additional or alternative information.

In some demonstrative aspects, controller 124 may be configured to control, trigger, cause, and/or instruct the UHR AP implemented by device 102 to broadcast the one or more UHR-update frames, for example, during the critical update period, e.g., as described below.

In some demonstrative aspects, controller 124 may be configured to control, trigger, cause, and/or instruct the UHR AP implemented by device 102 to transmit the UHR-update frame, for example, as a unicast critical update frame addressed to a UHR non-AP STA, e.g., as described below.

In some demonstrative aspects, controller 124 may be configured to control, trigger, cause, and/or instruct the UHR AP implemented by device 102 to transmit the unicast critical update frame, for example, based on a critical update request frame from the UHR non-AP STA, e.g., as described below.

In some demonstrative aspects, controller 154 may be configured to control, trigger, cause, and/or instruct a UHR non-AP STA implemented by device 140 to process a protected beacon frame to identify a UHR parameters update element, e.g., as described below.

In some demonstrative aspects, controller 154 may be configured to control, trigger, cause, and/or instruct the UHR non-AP STA implemented by device 140 to process the protected beacon frame received from a UHR AP, for example, during a critical update period of a critical update event, e.g., as described below.

For example, the protected beacon frame may include the protected beacon frame transmitted by device 102, e.g., as described above.

In some demonstrative aspects, controller 154 may be configured to control, trigger, cause, and/or instruct the UHR non-AP STA implemented by device 140 to process the UHR parameters update element to identify an updated setting of one or more UHR parameters to be updated by the UHR AP in the critical update event, e.g., as described below.

In some demonstrative aspects, controller 154 may be configured to control, trigger, cause, and/or instruct the UHR non-AP STA implemented by device 140 to configure the UHR non-AP STA to communicate with the UHR AP, for example, according to the updated setting of the one or more UHR parameters, e.g., as described below.

In some demonstrative aspects, controller 154 may be configured to control, trigger, cause, and/or instruct the UHR non-AP STA implemented by device 140 to configure the UHR non-AP STA to communicate with the UHR AP according to a first setting of the one or more UHR parameters, for example, based on UHR parameter information received from the UHR AP during association of the UHR non-AP STA with the UHR AP, e.g., as described below.

In some demonstrative aspects, controller 154 may be configured to control, trigger, cause, and/or instruct the UHR non-AP STA implemented by device 140 to reconfigure the UHR non-AP STA to communicate with the UHR AP according to a second setting of the one or more UHR parameters, for example, based on the UHR parameters update element, e.g., as described below.

In some demonstrative aspects, the second setting of the one or more UHR parameters may be different from the first setting of the one or more UHR parameters, e.g., as described below.

In some demonstrative aspects, controller 154 may be configured to control, trigger, cause, and/or instruct the UHR non-AP STA implemented by device 140 to process a count value in the protected beacon frame, for example, to identify a count of previous UHR parameter updates prior to the critical update event, e.g., as described below.

In some demonstrative aspects, controller 154 may be configured to control, trigger, cause, and/or instruct the UHR non-AP STA implemented by device 140 to process timing information in the protected beacon frame, for example, to identify a time at which the one or more UHR parameters are to be updated by the UHR AP, e.g., as described below.

In other aspects, controller 154 may be configured to control, trigger, cause, and/or instruct the UHR non-AP STA implemented by device 140 to process any other additional or alternative parameters and/or information in the protected beacon frame.

In some demonstrative aspects, controller 154 may be configured to mandate the UHR non-AP STA implemented by device 140 to enable beacon protection for beacon frames received from the UHR AP, e.g., as described below.

For example, controller 154 may be configured to control, trigger, cause, and/or instruct the UHR non-AP STA implemented by device 140 to enable beacon protection for the beacon frames from the UHR AP, for example, by configuring the UHR non-AP STA to process one or more, e.g., some or all, beacon frames, for example, according to a beacon protection scheme, e.g., in accordance with the IEEE 802.11 Standard.

For example, controller 154 may be configured to mandate the UHR non-AP STA implemented by device 140 to enable beacon protection, e.g., to mandatorily enable beacon protection, for all beacon frames received from the UHR AP, for example, including any beacon frames received from the UHR AP during the critical update period, and any beacon frames received from the UHR AP outside critical update periods.

In other aspects, controller 154 may be configured to mandate the UHR non-AP STA implemented by device 140 to enable beacon protection, e.g., to mandatorily enable beacon protection, for critical-update beacon frames received from the UHR AP during the critical update period, and to allow the UHR non-AP STA to disable beacon protection for non-critical-update beacon frames received from the UHR AP outside critical update periods.

In some demonstrative aspects, controller 154 may be configured to mandate the UHR non-AP STA implemented by device 140 to enable beacon protection, e.g., to mandatorily enable beacon protection, for all broadcast probe response frames received from the UHR AP, e.g., as described below.

For example, controller 154 may be configured to mandate the UHR non-AP STA implemented by device 140 to enable probe response protection, e.g., to mandatorily enable probe response protection, for all broadcast probe response frames received from the UHR AP, for example, including any broadcast probe response frames received from the UHR AP during the critical update period, and any broadcast probe response frames received from the UHR AP outside critical update periods.

In other aspects, controller 154 may be configured to mandate the UHR non-AP STA implemented by device 140 to enable probe response protection, e.g., to mandatorily enable probe response protection, for critical-update broadcast probe response frames received from the UHR AP during the critical update period, and to allow the UHR non-AP STA to disable probe response protection for non-critical-update broadcast probe response frames received from the UHR AP outside critical update periods.

In some demonstrative aspects, controller 154 may be configured to mandate the UHR non-AP STA implemented by device 140 to enable protection for all beacon frames and broadcast probe response frames received from the UHR AP, e.g., as described below.

For example, controller 154 may be configured to mandate the UHR non-AP STA implemented by device 140 to enable protection, e.g., to mandatorily enable protection, for all beacon frames and broadcast probe response frames received from the UHR AP, for example, including any beacon frames and broadcast probe response frames received from the UHR AP during the critical update period, and any beacon frames and broadcast probe response frames received from the UHR AP outside critical update periods.

In other aspects, controller 154 may be configured to mandate the UHR non-AP STA implemented by device 140 to enable protection, e.g., to mandatorily enable protection, for critical-update beacon frames and broadcast probe response frames received from the UHR AP during the critical update period, and to allow the UHR non-AP STA to disable protection for non-critical-update beacon frames and broadcast probe response frames received from the UHR AP outside critical update periods.

In some demonstrative aspects, controller 154 may be configured to control, trigger, cause, and/or instruct the UHR non-AP STA implemented by device 140 to decapsulate the protected beacon frame from the UHR AP, for example, according to the BIP, e.g., as described below.

In some demonstrative aspects, controller 154 may be configured to control, trigger, cause, and/or instruct the UHR non-AP STA implemented by device 140 to process the protected beacon frame from the UHR AP, for example, according to a BIGTK received from the UHR AP, e.g., as described below.

In other aspects, controller 154 may be configured to control, trigger, cause, and/or instruct the UHR non-AP STA implemented by device 140 to process the protected beacon frame according to any other additional or alternative key and/or protection mechanism.

In some demonstrative aspects, controller 154 may be configured to control, trigger, cause, and/or instruct the UHR non-AP STA implemented by device 140 to process an unsolicited protected probe response frame received from the UHR AP during the critical update period, for example, to identify the UHR parameters update element, e.g., as described below.

In one example, controller 154 may be configured to control, trigger, cause, and/or instruct the UHR non-AP STA implemented by device 140 to process the UHR parameters update element, which may be included in one or more unsolicited protected probe response frames, and in one or more protected beacon frames, which may be received from the UHR AP during the critical update period.

In another example, controller 154 may be configured to control, trigger, cause, and/or instruct the UHR non-AP STA implemented by device 140 to process the UHR parameters update element, which may be included in one or more unsolicited protected probe response frames, for example, instead of being included in one or more, e.g., some or all, protected beacon frames, during the critical update period.

In another example, controller 154 may be configured to control, trigger, cause, and/or instruct the UHR non-AP STA implemented by device 140 to process one or more beacon frames, which may not include the UHR parameters update element, received from the UHR AP during a critical update period.

In some demonstrative aspects, controller 154 may be configured to control, trigger, cause, and/or instruct the UHR non-AP STA implemented by device 140 to process the unsolicited protected probe response frame, for example, according to a BIGTK received from the UHR AP, e.g., as described below.

In other aspects, controller 154 may be configured to control, trigger, cause, and/or instruct the UHR non-AP STA implemented by device 140 to process the unsolicited protected probe response frame according to any other additional or alternative key and/or protection mechanism.

In some demonstrative aspects, controller 154 may be configured to control, trigger, cause, and/or instruct the UHR non-AP STA implemented by device 140 to process the one or more UHR parameters, which are included in the UHR parameters update element, to identify one or more long-term static parameters, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more UHR capability parameters corresponding to one or more UHR capabilities of the UHR AP, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more BSS parameters of a BSS of the UHR AP, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more NPCA parameters, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more DPS parameters, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more EDCA parameters, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more DSO parameters, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more DUO parameters, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more DBE parameters, e.g., as described below.

In some demonstrative aspects, controller 154 may be configured to control, trigger, cause, and/or instruct the UHR non-AP STA implemented by device 140 to process the one or more UHR parameters, which are included in the UHR parameters update element, to identify one or more AP PS parameters, e.g., as described below.

In other aspects, controller 154 may be configured to control, trigger, cause, and/or instruct the UHR non-AP STA implemented by device 140 to process the one or more UHR parameters, which are included in the UHR parameters update element, to identify any other additional or alternative parameters and/or information.

In some demonstrative aspects, controller 154 may be configured to control, trigger, cause, and/or instruct the UHR non-AP STA implemented by device 140 to transmit a probe request frame to the UHR AP, e.g., as described below.

For example, controller 154 may be configured to control, trigger, cause, and/or instruct the UHR non-AP STA implemented by device 140 to transmit the probe request frame to the UHR AP, for example, based on identification of a UHR parameter update by the UHR AP. In one example, controller 154 may be configured to control, trigger, cause, and/or instruct the UHR non-AP STA implemented by device 140 to identify the UHR parameter update by the UHR AP, for example, based on receipt of one or more critical update frames from the UHR AP, e.g., according to a critical update procedure.

In some demonstrative aspects, controller 154 may be configured to control, trigger, cause, and/or instruct the UHR non-AP STA implemented by device 140 to process the UHR parameters update element in a unicast probe response frame received from the UHR AP, for example, based on the probe request frame, e.g., as described below.

In some demonstrative aspects, controller 154 may be configured to control, trigger, cause, and/or instruct the UHR non-AP STA implemented by device 140 to process one or more UHR-update frames received from the UHR AP during the critical update period, e.g., as described below.

In some demonstrative aspects, controller 154 may be configured to control, trigger, cause, and/or instruct the UHR non-AP STA implemented by device 140 to process a UHR-update frame of the one or more UHR-update frames, for example, to identify the UHR parameters update element, e.g., as described below.

In some demonstrative aspects, the UHR-update frame may be configured to include an update-dedicated frame dedicated to carry the UHR parameters update element, e.g., as described below.

In some demonstrative aspects, the one or more UHR-update frames may include broadcast frames, e.g., as described below.

In some demonstrative aspects, the UHR-update frame may include any other additional or alternative information.

In some demonstrative aspects, controller 154 may be configured to control, trigger, cause, and/or instruct the UHR non-AP STA implemented by device 140 to transmit a critical update request frame to the UHR AP, e.g., as described below.

For example, controller 154 may be configured to control, trigger, cause, and/or instruct the UHR non-AP STA implemented by device 140 to transmit the critical update request frame to the UHR AP, for example, based on identification of a UHR parameter update by the UHR AP. In one example, controller 154 may be configured to control, trigger, cause, and/or instruct the UHR non-AP STA implemented by device 140 to identify the UHR parameter update by the UHR AP, for example, based on receipt of one or more critical update frames from the UHR AP, e.g., according to a critical update procedure.

In some demonstrative aspects, controller 154 may be configured to control, trigger, cause, and/or instruct the UHR non-AP STA implemented by device 140 to process a unicast critical update frame addressed to the UHR non-AP STA from the UHR AP, e.g., as described below.

In some demonstrative aspects, device 102 and/or device 140 may be configured to perform one or more operations and/or functionalities of one or more UHR parameters update mechanisms, which may be configured to support a UHR non-AP STA in retrieving critical updates from a UHR AP, including, for example, one or more, e.g., some or all, fields of a UHR operation element and/or a UHR Capabilities element that are being changed and/or updated, e.g., as described below.

In some demonstrative aspects, device 102 and/or device 140 may be configured to perform one or more operations and/or functionalities of a first UHR parameters update mechanism, which may be configured to support communication of critical updates in beacon frames during a critical update period, e.g., as described below.

In some demonstrative aspects, it may be defined, e.g., according to the first UHR parameters update mechanism, that an AP, e.g., a UHR AP, which is to perform a critical update, is to include the elements or fields, which are to be updated by the corresponding critical update, in one or more, e.g., some or all, beacon frames and probe response frames transmitted by the AP, for example, during a limited time period.

For example, the limited time period may include a period starting when the critical update is announced by the AP and until the critical update takes effect, e.g., the time at which the parameters are effectively changed.

For example, it may be defined, e.g., according to the first UHR parameters update mechanism, that any other affiliated APs in the same AP MLD as the AP that has the critical update are to include the elements or fields, which are to be updated by the corresponding critical update, in one or more, e.g., some or all, beacon frames and probe response frames transmitted by the affiliated APs.

In some demonstrative aspects, device 102 and/or device 140 may be configured to perform one or more operations and/or functionalities of a second UHR parameters update mechanism, which may be configured to support communication of critical updates in an unsolicited probe response frame that is broadcasted and protected, e.g., as described below.

In some demonstrative aspects, it may be defined, e.g., according to the second UHR parameters update mechanism, that probe response frame protection is to be implemented, for example, similar to a beacon frame protection.

For example, it may be defined, e.g., according to the second UHR parameters update mechanism, that the probe response frame protection may be configured to utilize a Mobility Management Entity (MME) and/or Message Integrity Check (MIC) element which may be implemented, for example, at the end of an unsolicited probe response frame, for example, with a Broadcast Key that is given to the non-AP STA in order to verify that the unsolicited probe response frame is really from an intended transmitter, e.g., the AP.

In some demonstrative aspects, it may be defined, e.g., according to the second UHR parameters update mechanism, that an AP supporting beacon frame protection, e.g., a UHR AP, may, e.g., shall, enable also broadcast probe response protection.

In other aspects, it may be defined, e.g., according to the second UHR parameters update mechanism, that a dedicated capability for broadcast probe response protection may be implemented.

In some demonstrative aspects, it may be defined, e.g., according to the second UHR parameters update mechanism, that the AP, e.g., the UHR AP, and the non-AP STA, e.g., the UHR non-AP STA, are to use the same key, for example, a BIGTK, for beacon protection and probe response protection.

In some demonstrative aspects, it may be defined, e.g., according to the second UHR parameters update mechanism, that in an infrastructure BSS, for example, when beacon protection is enabled at the UHR non-AP STA, the MAC Layer Management Entity (MLME) may, e.g., shall, provide an encapsulation service for beacon frames and/or probe response frames.

For example, it may be defined, e.g., according to the second UHR parameters update mechanism, that one or more, e.g., some or all, beacon frames and/or one or more, e.g., some or all, broadcast probe response frames may, e.g., shall, be submitted to this service for protection processing.

In some demonstrative aspects, it may be defined, e.g., according to the second UHR parameters update mechanism, that the AP, e.g., the UHR AP, may, e.g., shall, enable beacon protection, and set a Beacon Protection Enabled field of an Extended Capabilities element to 1, for example, to indicate that beacon protection is enabled, for example, if dot11BeaconProtectionEnabled is true, e.g., in accordance with the IEEE 802.11 Standard. For example, it may be defined, e.g., according to the second UHR parameters update mechanism, that otherwise, e.g., if dot11BeaconProtectionEnabled is not true, the UHR AP may, e.g., shall, set the Beacon Protection Enabled field of the Extended Capabilities element to 0, for example, to indicate that beacon protection is disabled, e.g., in accordance with the IEEE 802.11 Standard.

In some demonstrative aspects, it may be defined, e.g., according to the second UHR parameters update mechanism, that a non-AP STA, e.g., a UHR non-AP STA, may, e.g., shall, enable beacon protection and probe response protection, for example, if dot11BeaconProtectionEnabled is true, e.g., in accordance with the IEEE 802.11 Standard, and the non-AP STA, e.g., the UHR non-AP STA, receives a BIGTK from the UHR AP with which it is associated. For example, it may be defined that otherwise, beacon protection and probe response protection may not be enabled at the non-AP STA.

For example, it may be defined, e.g., according to the second UHR parameters update mechanism, that, in a multiple BSSID set, a non-AP STA, e.g., a UHR non-AP STA, is to receive the BIGTK from its associated AP, which may correspond to either a transmitted BSSID or non-transmitted BSSID. For example, it may be defined that the non-AP STA, e.g., the UHR non-AP STA, is to use the BIGTK from its associated AP for validating the contents of a beacon frame transmitted by the AP corresponding to the transmitted BSSID, e.g., in accordance with the IEEE 802.11 Standard.

For example, it may be defined, e.g., according to the second UHR parameters update mechanism, that a probe response protection service shall take one or more actions e.g., some or all of the following actions:
Probe Response frame protection shall be set using the MLME-SETPROTECTION.request primitive with the Protectlist including a Key Type value of BIGTK, e.g., in accordance with the IEEE 802.11 Standard. A non-AP STA shall also set a Protect Type value to Rx. An AP shall set a Protect Type value to Tx.
The BIGTK shall be installed using the MLME-SETKEYS.request primitive with the value BIGTK for the Key Type parameter, e.g., in accordance with the IEEE 802.11 Standard.
The Probe Response frames shall be encapsulated and protected using BIP, e.g., in accordance with the IEEE 802.11 Standard.
The protected Probe Response frames shall be decapsulated and validated using BIP, e.g., in accordance with the IEEE 802.11 Standard.

For example, it may be defined, e.g., according to the second UHR parameters update mechanism, that dot11BeaconProtectionEnabled may, e.g., shall, be set to false, for example, if dot11RSNAProtectedManagementFramesActivated is false.

For example, it may be defined, e.g., according to the second UHR parameters update mechanism, that if Operating Channel Validation Capable (OCVC) is not present in a non-AP STA, e.g., a UHR non-AP STA, or if the current AP does not advertise OCVC, but beacon protection and/or probe response protection is enabled, then the non-AP STA may, e.g. shall, verify that operating channel information in a first received beacon frame that has been validated using BIP matches the current operating channel parameters. For example, the non-AP STA may, e.g., shall, disassociate from the AP, for example, if there is a mismatch between the operating channel information and the current operating channel parameters.

In some demonstrative aspects, device 102 and/or device 140 may be configured to perform one or more operations and/or functionalities of a third UHR parameters update mechanism, which may be configured to support communication of an Individually-Addressed probe response frame, e.g., as described below.

For example, according to the third UHR parameters update mechanism, an Individually-Addressed probe response frame may be defined as a Robust Management frame. For example, the Individually-Addressed probe response frame may be protected similar to protection of an Individually-addressed Robust Management frame, for example, following an Individually addressed management frame protection framework, e.g., in accordance with the IEEE 802.11 Standard.

In some demonstrative aspects, device 102 and/or device 140 may be configured to perform one or more operations and/or functionalities of a fourth UHR parameters update mechanism, which may be configured to support communication of a Protected Critical Update Action frame, e.g., as described below.

For example, according to the fourth UHR parameters update mechanism, a Protected Critical Update Action frame may be defined, for example, to contain one or more fields and/or elements that correspond to a critical update. For example, the Protected Critical Update Action frame may be configured to, e.g., possibly, include a UHR BSS Parameter Check Count field, that is incremented every time there is an update, and that may therefore allow a non-AP STA, e.g., a UHR non-AP STA, to correlate what element gets updated by which update number.

For example, the Protected Critical Update Action frame may be configured as a frame carrying the same information as a probe response frame, which may support providing complete information for an AP, e.g., an UHR AP.

For example, the Protected Critical Update Action frame may be configured to provide complete information of multiple APs affiliated with an AP MLD, for example, in a manner similar to a Multi-link probe response. For example, the Protected Critical Update Action frame may be configured as a Protected action frame, for example, such that its contents may be protected by applying a baseline Management frame protection.

For example, a Protected Critical Update Request action frame may be configured to support a non-AP STA, e.g., an UHR non-AP STA, which may request an AP, e.g., a UHR AP, to send the critical update to the non-AP STA. For example, the Protected Critical Update Request action frame may be unicasted to the AP and acknowledged by the AP.

For example, the AP may send the Protected Critical Update Action frame unicasted to the STA, e.g., right away or at a later time.

For example, the AP may send the Protected Critical Update Action frame, which may be protected, for example, using an Individually-addressed protected management frame protocol, or any other suitable protection mechanism.

For example, the AP may broadcast the Protected Critical Update Action frame, which may be protected, for example, according to the Broadcast protected management frame protocol, or any other suitable protection mechanism.

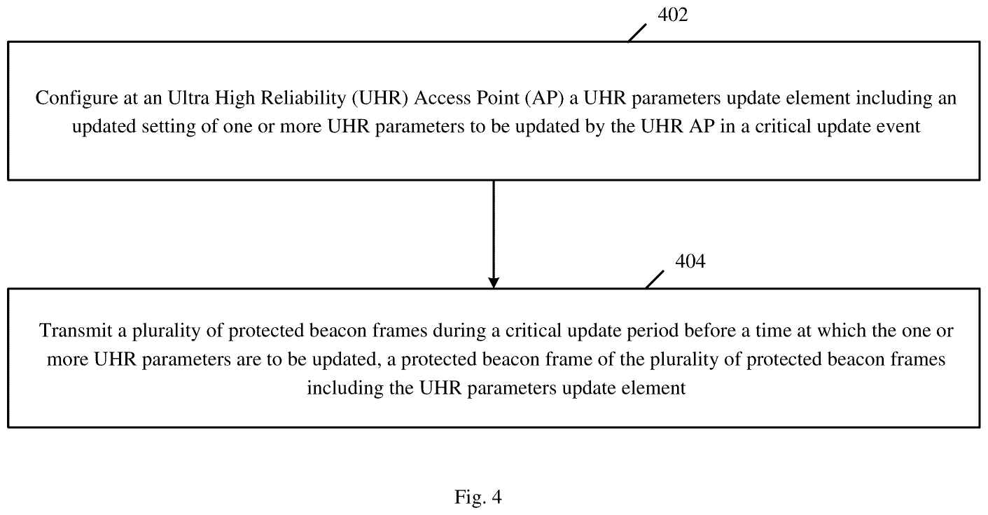

Reference is made to FIG. 4, which schematically illustrates a method of a UHR parameters update, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include configuring, at a UHR AP, a UHR parameters update element. For example, the UHR parameters update element may include an updated setting of one or more UHR parameters to be updated by the UHR AP in a critical update event. For example, controller 124 (FIG. 1) may be configured to cause, trigger, and/or control a UHR AP implemented by device 102 (FIG. 1) to configure a UHR parameters update element including an updated setting of one or more UHR parameters to be updated by the UHR AP in a critical update event, e.g., as described above.

As indicated at block 404, the method may include transmitting from the UHR AP a plurality of protected beacon frames during a critical update period before a time at which the one or more UHR parameters are to be updated. For example, a protected beacon frame of the plurality of protected beacon frames may include the UHR parameters update element. For example, controller 124 (FIG. 1) may be configured to cause, trigger, and/or control the UHR AP implemented by device 102 (FIG. 1) to transmit a plurality of protected beacon frames during a critical update period before a time at which the one or more UHR parameters are to be updated, a protected beacon frame of the plurality of protected beacon frames including the UHR parameters update element, e.g., as described above.

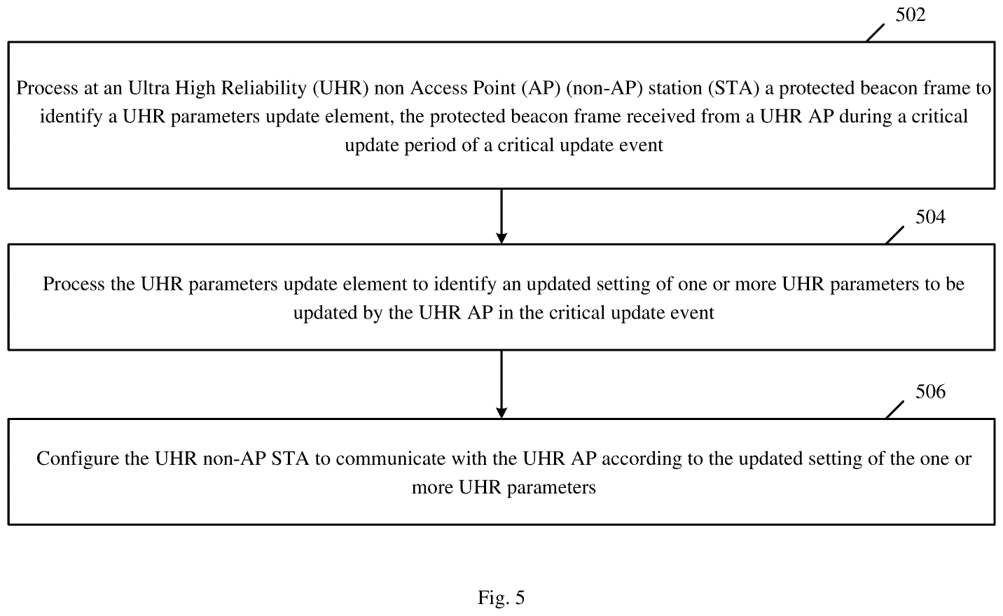

Reference is made to FIG. 5, which schematically illustrates a method of a UHR parameters update, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include processing, at a UHR non-AP STA, a protected beacon frame to identify a UHR parameters update element. For example, the protected beacon frame may be received from a UHR AP during a critical update period of a critical update event. For example, controller 154 (FIG. 1) may be configured to cause, trigger, and/or control a UHR non-AP STA implemented by device 140 (FIG. 1) to process a protected beacon frame to identify a UHR parameters update element, the protected beacon frame received from a UHR AP, e.g., a UHR AP implemented by device 102 (FIG. 1), during a critical update period of a critical update event, e.g., as described above.

As indicated at block 504, the method may include processing the UHR parameters update element to identify an updated setting of one or more UHR parameters to be updated by the UHR AP in the critical update event. For example, controller 154 (FIG. 1) may be configured to cause, trigger, and/or control the UHR non-AP STA implemented by device 140 (FIG. 1) to process the UHR parameters update element to identify an updated setting of one or more UHR parameters to be updated by the UHR AP in the critical update event, e.g., as described above.

As indicated at block 506, the method may include configuring the UHR non-AP STA to communicate with the UHR AP, for example, according to the updated setting of the one or more UHR parameters. For example, controller 154 (FIG. 1) may be configured to cause, trigger, and/or control device 140 (FIG. 1) to configure the UHR non-AP STA implemented by device 140 (FIG. 1) to communicate with the UHR AP implemented by device 102 (FIG. 1), for example, according to the updated setting of the one or more UHR parameters, e.g., as described above.

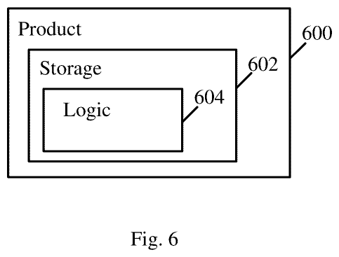

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1, 2, 3, 4, and/or 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to cause an Ultra High Reliability (UHR) Access Point (AP) to configure a UHR parameters update element comprising an updated setting of one or more UHR parameters to be updated by the UHR AP in a critical update event; and transmit a plurality of protected beacon frames during a critical update period before a time at which the one or more UHR parameters are to be updated, a protected beacon frame of the plurality of protected beacon frames comprising the UHR parameters update element; and a memory to store information processed by the processor.

Example 2 includes the subject matter of Example 1, and optionally, wherein the apparatus is configured to cause the UHR AP to protect the plurality of protected beacon frames according to a Beacon Integrity Group Temporal Key (BIGTK), which is provided by the UHR AP to one or more associated UHR non-AP stations (STAs).

Example 3 includes the subject matter of Example 1 or 2, and optionally, wherein the apparatus is configured to cause an other UHR AP, which belongs to a same AP Multi-Link Device (MLD) as the UHR AP, to transmit an other plurality of protected beacon frames comprising the UHR parameters update element during the critical update period.

Example 4 includes the subject matter of any one of Examples 1-3, and optionally, wherein the apparatus is configured to mandate the UHR AP to protect all beacon frames transmitted by the UHR AP.

Example 5 includes the subject matter of any one of Examples 1-4, and optionally, wherein the apparatus is configured to cause the UHR AP to broadcast one or more unsolicited protected probe response frames during the critical update period, a protected probe response frame of the plurality of unsolicited protected probe response frames comprising the UHR parameters update element.

Example 6 includes the subject matter of Example 5, and optionally, wherein the apparatus is configured to cause the UHR AP to protect the unsolicited protected probe response frames according to a Beacon Integrity Group Temporal Key (BIGTK), which is provided by the UHR AP to one or more associated UHR non-AP stations (STAs).

Example 7 includes the subject matter of Example 5 or 6, and optionally, wherein the apparatus is configured to mandate the UHR AP to protect all broadcast probe response frames transmitted by the UHR AP.

Example 8 includes the subject matter of any one of Examples 1-7, and optionally, wherein the apparatus is configured to mandate the UHR AP to protect all beacon frames and broadcast probe response frames transmitted by the UHR AP.

Example 9 includes the subject matter of any one of Examples 1-8, and optionally, wherein the apparatus is configured to cause the UHR AP to exclude the one or more UHR parameters from non-critical update beacon frames, which are transmitted outside critical update periods.

Example 10 includes the subject matter of any one of Examples 1-9, and optionally, wherein the one or more UHR parameters comprises one or more UHR capability parameters corresponding to one or more UHR capabilities of the UHR AP.

Example 11 includes the subject matter of any one of Examples 1-10, and optionally, wherein the one or more UHR parameters comprises one or more Basic Service Set (BSS) parameters of a BSS of the UHR AP.

Example 12 includes the subject matter of any one of Examples 1-11, and optionally, wherein the one or more UHR parameters comprises at least one of one or more Non-Primary Channel Access (NPCA) parameters, one or more Dynamic power save (DPS) parameters, one or more Enhanced Distributed Channel Access (EDCA) parameters, one or more Dynamic Subband Operation (DSO) parameters, one or more Dynamic Unavailability Operation (DUO) parameters, one or more Dynamic Bandwidth Expansion (DBE) parameters, or one or more AP Power-Save (PS) parameters.

Example 13 includes the subject matter of any one of Examples 1-12, and optionally, wherein the one or more UHR parameters comprises one or more long-term static parameters.

Example 14 includes the subject matter of any one of Examples 1-13, and optionally, wherein the apparatus is configured to cause the UHR AP to encapsulate the protected beacon frame according to a Broadcast/multicast Integrity Protocol (BIP).

Example 15 includes the subject matter of any one of Examples 1-14, and optionally, wherein the apparatus is configured to cause the UHR AP to transmit a unicast probe response frame to a UHR non-AP station (STA) based on a probe request frame received from the UHR non-AP STA, wherein the unicast probe response frame comprises the UHR parameters update element.

Example 16 includes the subject matter of any one of Examples 1-15, and optionally, wherein the apparatus is configured to cause the UHR AP to transmit one or more UHR-update frames during the critical update period, a UHR-update frame of the one or more UHR-update frames comprising the UHR parameters update element.

Example 17 includes the subject matter of Example 16, and optionally, wherein the UHR-update frame comprises an update-dedicated frame dedicated to carry the UHR parameters update element.

Example 18 includes the subject matter of Example 16 or 17, and optionally, wherein the apparatus is configured to cause the UHR AP to broadcast the one or more UHR-update frames during the critical update period.

Example 19 includes the subject matter of any one of Examples 16-18, and optionally, wherein the apparatus is configured to cause the UHR AP to transmit the UHR-update frame as a unicast critical update frame addressed to a UHR non-AP station (STA).

Example 20 includes the subject matter of Example 19, and optionally, wherein the apparatus is configured to cause the UHR AP to transmit the unicast critical update frame based on a critical update request frame from the UHR non-AP STA.

Example 21 includes the subject matter of any one of Examples 1-20, and optionally, wherein the protected beacon frame comprises a count value based on a count of previous UHR parameter updates prior to the critical update event.

Example 22 includes the subject matter of any one of Examples 1-21, and optionally, wherein the protected beacon frame comprises timing information based on the time at which the one or more UHR parameters are to be updated.

Example 23 includes the subject matter of any one of Examples 1-22, and optionally, comprising a radio to transmit the plurality of protected beacon frames.

Example 24 includes the subject matter of Example 23, and optionally, comprising one or more antennas connected to the radio, and another processor to execute instructions of an operating system.

Example 25 includes an apparatus comprising a processor configured to cause an Ultra High Reliability (UHR) non Access Point (AP) (non-AP) station (STA) to process a protected beacon frame to identify a UHR parameters update element, the protected beacon frame received from a UHR AP during a critical update period of a critical update event; process the UHR parameters update element to identify an updated setting of one or more UHR parameters to be updated by the UHR AP in the critical update event; and configure the UHR non-AP STA to communicate with the UHR AP according to the updated setting of the one or more UHR parameters; and a memory to store information processed by the processor.

Example 26 includes the subject matter of Example 25, and optionally, wherein the apparatus is configured to cause the UHR non-AP STA to configure the UHR non-AP STA to communicate with the UHR AP according to a first setting of the one or more UHR parameters based on UHR parameter information received from the UHR AP during association of the UHR non-AP STA with the UHR AP; and reconfigure the UHR non-AP STA to communicate with the UHR AP according to a second setting of the one or more UHR parameters based on the UHR parameters update element, the second setting of the one or more UHR parameters different from the first setting of the one or more UHR parameters.

Example 27 includes the subject matter of Example 25 or 26, and optionally, wherein the apparatus is configured to cause the UHR non-AP STA to process the protected beacon frame according to a Beacon Integrity Group Temporal Key (BIGTK) received from the UHR AP.

Example 28 includes the subject matter of any one of Examples 25-27, and optionally, wherein the apparatus is configured to mandate the UHR non-AP STA to enable beacon protection for all beacon frames from the UHR AP.

Example 29 includes the subject matter of any one of Examples 25-28, and optionally, wherein the apparatus is configured to cause the UHR non-AP STA to process an unsolicited protected probe response frame received from the UHR AP during the critical update period to identify the UHR parameters update element.

Example 30 includes the subject matter of Example 29, and optionally, wherein the apparatus is configured to cause the UHR non-AP STA to process the unsolicited protected probe response frame according to a Beacon Integrity Group Temporal Key (BIGTK) received from the UHR AP.

Example 31 includes the subject matter of Example 29 or 30, and optionally, wherein the apparatus is configured to mandate the UHR non-AP STA to enable probe response protection for all broadcast probe response frames from the UHR AP.

Example 32 includes the subject matter of any one of Examples 25-31, and optionally, wherein the apparatus is configured to mandate the UHR non-AP STA to enable protection for all beacon frames and broadcast probe response frames from the UHR AP.

Example 33 includes the subject matter of any one of Examples 25-32, and optionally, wherein the one or more UHR parameters comprises one or more UHR capability parameters corresponding to one or more UHR capabilities of the UHR AP.

Example 34 includes the subject matter of any one of Examples 25-33, and optionally, wherein the one or more UHR parameters comprises one or more Basic Service Set (BSS) parameters of a BSS of the UHR AP.

Example 35 includes the subject matter of any one of Examples 25-34, and optionally, wherein the one or more UHR parameters comprises at least one of one or more Non-Primary Channel Access (NPCA) parameters, one or more Dynamic power save (DPS) parameters, one or more Enhanced Distributed Channel Access (EDCA) parameters, one or more Dynamic Subband Operation (DSO) parameters, one or more Dynamic Unavailability Operation (DUO) parameters, one or more Dynamic Bandwidth Expansion (DBE) parameters, or one or more AP Power-Save (PS) parameters.

Example 36 includes the subject matter of any one of Examples 25-35, and optionally, wherein the one or more UHR parameters comprises one or more long-term static parameters.

Example 37 includes the subject matter of any one of Examples 25-36, and optionally, wherein the apparatus is configured to cause the UHR non-AP STA to decapsulate the protected beacon frame according to a Broadcast/multicast Integrity Protocol (BIP).

Example 38 includes the subject matter of any one of Examples 25-37, and optionally, wherein the apparatus is configured to cause the UHR non-AP STA to transmit a probe request frame to the UHR AP, and to process the UHR parameters update element in a unicast probe response frame received from the UHR AP based on the probe request frame.

Example 39 includes the subject matter of any one of Examples 25-38, and optionally, wherein the apparatus is configured to cause the UHR non-AP STA to process one or more UHR-update frames received from the UHR AP during the critical update period, a UHR-update frame of the one or more UHR-update frames comprising the UHR parameters update element.

Example 40 includes the subject matter of Example 39, and optionally, wherein the UHR-update frame comprises an update-dedicated frame dedicated to carry the UHR parameters update element.

Example 41 includes the subject matter of Example 39 or 40, and optionally, wherein the one or more UHR-update frames comprise broadcast frames.

Example 42 includes the subject matter of any one of Examples 39-41, and optionally, wherein the apparatus is configured to cause the UHR non-AP STA to transmit a critical update request frame to the UHR AP, and to process a unicast critical update frame addressed to the UHR non-AP STA from the UHR AP.

Example 43 includes the subject matter of any one of Examples 25-42, and optionally, wherein the apparatus is configured to cause the UHR non-AP STA to process a count value in the protected beacon frame to identify a count of previous UHR parameter updates prior to the critical update event.

Example 44 includes the subject matter of any one of Examples 25-43, and optionally, wherein the apparatus is configured to cause the UHR non-AP STA to process timing information in the protected beacon frame to identify a time at which the one or more UHR parameters are to be updated by the UHR AP.

Example 45 includes the subject matter of any one of Examples 25-44, and optionally, comprising a radio to receive the protected beacon frame.

Example 46 includes the subject matter of Example 45, and optionally, comprising one or more antennas connected to the radio, and another processor to execute instructions of an operating system.

Example 47 includes a wireless communication device comprising the apparatus of any of Examples 1-46.

Example 48 includes a mobile device comprising the apparatus of any of Examples 1-46.

Example 49 includes an apparatus comprising means for executing any of the described operations of any of Examples 1-46.

Example 50 includes a product comprising one or more tangible computer-readable non-transitory storage media comprising instructions operable to, when executed by at least one processor, enable the at least one processor to cause any of the described operations of any of Examples 1-46.

Example 51 includes an apparatus comprising: a memory interface; and processing circuitry configured to: perform any of the described operations of any of Examples 1-46.

Example 52 includes a method comprising any of the described operations of any of Examples 1-46.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause an Ultra High Reliability (UHR) Access Point (AP) to:
configure a UHR parameters update element comprising an updated setting of one or more UHR parameters to be updated by the UHR AP in a critical update event; and
transmit a plurality of protected beacon frames during a critical update period before a time at which the one or more UHR parameters are to be updated, a protected beacon frame of the plurality of protected beacon frames comprising the UHR parameters update element; and
a memory to store information processed by the processor.

2. The apparatus of claim 1 configured to cause the UHR AP to protect the plurality of protected beacon frames according to a Beacon Integrity Group Temporal Key (BIGTK), which is provided by the UHR AP to one or more associated UHR non-AP stations (STAs).

3. The apparatus of claim 1 configured to cause an other UHR AP, which belongs to a same AP Multi-Link Device (MLD) as the UHR AP, to transmit an other plurality of protected beacon frames comprising the UHR parameters update element during the critical update period.

4. The apparatus of claim 1 configured to mandate the UHR AP to protect all beacon frames transmitted by the UHR AP.

5. The apparatus of claim 1 configured to cause the UHR AP to broadcast one or more unsolicited protected probe response frames during the critical update period, a protected probe response frame of the plurality of unsolicited protected probe response frames comprising the UHR parameters update element.

6. The apparatus of claim 5 configured to cause the UHR AP to protect the unsolicited protected probe response frames according to a Beacon Integrity Group Temporal Key (BIGTK), which is provided by the UHR AP to one or more associated UHR non-AP stations (STAs).

7. The apparatus of claim 5 configured to mandate the UHR AP to protect all broadcast probe response frames transmitted by the UHR AP.

8. The apparatus of claim 1 configured to mandate the UHR AP to protect all beacon frames and broadcast probe response frames transmitted by the UHR AP.

9. The apparatus of claim 1 configured to cause the UHR AP to exclude the one or more UHR parameters from non-critical update beacon frames, which are transmitted outside critical update periods.

10. The apparatus of claim 1, wherein the one or more UHR parameters comprises one or more UHR capability parameters corresponding to one or more UHR capabilities of the UHR AP.

11. The apparatus of claim 1, wherein the one or more UHR parameters comprises one or more Basic Service Set (BSS) parameters of a BSS of the UHR AP.

12. The apparatus of claim 1, wherein the one or more UHR parameters comprises at least one of one or more Non-Primary Channel Access (NPCA) parameters, one or more Dynamic power save (DPS) parameters, one or more Enhanced Distributed Channel Access (EDCA) parameters, one or more Dynamic Subband Operation (DSO) parameters, one or more Dynamic Unavailability Operation (DUO) parameters, one or more Dynamic Bandwidth Expansion (DBE) parameters, or one or more AP Power-Save (PS) parameters.

13. The apparatus of claim 1, wherein the one or more UHR parameters comprises one or more long-term static parameters.

14. The apparatus of claim 1 configured to cause the UHR AP to encapsulate the protected beacon frame according to a Broadcast/multicast Integrity Protocol (BIP).

15. The apparatus of claim 1 configured to cause the UHR AP to transmit a unicast probe response frame to a UHR non-AP station (STA) based on a probe request frame received from the UHR non-AP STA, wherein the unicast probe response frame comprises the UHR parameters update element.

16. The apparatus of claim 1 configured to cause the UHR AP to transmit one or more UHR-update frames during the critical update period, a UHR-update frame of the one or more UHR-update frames comprising the UHR parameters update element.

17. The apparatus of claim 1, wherein the protected beacon frame comprises a count value based on a count of previous UHR parameter updates prior to the critical update event.

18. The apparatus of claim 1 comprising a radio to transmit the plurality of protected beacon frames, one or more antennas connected to the radio, and another processor to execute instructions of an operating system.

19. A product comprising one or more tangible computer-readable non-transitory storage media comprising instructions operable to, when executed by at least one processor, enable the at least one processor to cause an Ultra High Reliability (UHR) Access Point (AP) to:
configure a UHR parameters update element comprising an updated setting of one or more UHR parameters to be updated by the UHR AP in a critical update event; and
transmit a plurality of protected beacon frames during a critical update period before a time at which the one or more UHR parameters are to be updated, a protected beacon frame of the plurality of protected beacon frames comprising the UHR parameters update element.

20. The product of claim 19, wherein the instructions, when executed, cause the UHR AP to protect the plurality of protected beacon frames according to a Beacon Integrity Group Temporal Key (BIGTK), which is provided by the UHR AP to one or more associated UHR non-AP stations (STAs).
